(19) United States
(12) Patent Application Publication
(10) Pub. No.: US 2021/0297941 A1
(43) Pub. Date: Sep. 23, 2021

(54) MOBILE NETWORK OPERATOR SELECTION

(71) Applicant: BRITISH TELECOMMUNICATIONS PUBLIC LIMITED COMPANY, LONDON (GB)

(72) Inventors: Ruth BROWN, London (GB); Jonathan HART, London (GB)

(21) Appl. No.: 17/250,697

(22) PCT Filed: Jul. 22, 2019
(86) PCT No.: PCT/EP2019/069662

§ 371 Date: Feb. 19, 2021

(30) Foreign Application Priority Data
Aug. 23, 2018 (EP) 18190573.8

(51) Int. Cl. H04W 48/18; H04W 60/00

(52) U.S. Cl. CPC H04W 48/18; H04W 60/00

(57) ABSTRACT

A method of selecting a mobile network operator for a network communication from a wireless communication device, the wireless communication device being registered with a default mobile network operator, including receiving, from the wireless communication device, the network communication at a radio access network shared by a plurality of mobile network operators; identifying, from the plurality of mobile network operators, an improved mobile network operator having an improved network characteristic compared to the default mobile network operator; and selecting the improved mobile network operator through which to route the network communication.

### PRIORITY CLAIM

The present application is a National Phase entry of PCT Application No. PCT/EP2019/069662, filed Jul. 22, 2019, which claims priority from EP Patent Application No. 18190573.8, filed Aug. 23, 2018, each of which is hereby fully incorporated herein by reference.

### TECHNICAL FIELD

The present disclosure relates to a telecommunications network, and in particular to a telecommunication network for selecting a mobile network operator from a plurality of mobile network operators that share a radio access network.

### BACKGROUND

Mobile Network Operators (MNOs) often share network resources, not least for cost efficiency.

For example, MNOs might share a Radio Access Network (RAN) by way of a RAN-share agreement.

In an example of a RAN-share agreement, MNOs broadcast from a shared site, albeit at different radio frequencies (referred to as a Mobile Operator Radio Access Network—MORAN—arrangement). In another example, MNOs broadcast from a shared site and also share radio spectrum (referred to as a Multi-Operator Core Network—MOCN—arrangement).

Regardless of the RAN-sharing method that is used, under existing arrangements only the RAN is shared. Each MNO connects their mobile users into their own core network; this does not necessarily yield the best results for users or for MNOs. It is therefore an aim of the present invention at least to alleviate this problem.

### SUMMARY

According to a first aspect of the present disclosure, there is provided a method of selecting a mobile network operator for a network communication from a wireless communication device (herein also referred to a “User Equipment” or a “UE”), the wireless communication device being registered with a default mobile network operator, comprising receiving, from the wireless communication device, the network communication at a radio access network shared by a plurality of mobile network operators; identifying, from the plurality of mobile network operators, an improved mobile network operator having an improved network characteristic compared to the default mobile network operator; and selecting the improved mobile network operator through which to route (or to continue to route) the network communication.

As used herein, the term “shared” in the context of mobile network operators sharing a radio access network, preferably connotes the availability for a wireless communication device to access a plurality of mobile network operators from the same hardware and/or location of a radio access network access point, including: the cell site; radio spectrum; antennas; processing hardware; and/or other infrastructure.

The default mobile network operator may be the home mobile network operator or a preferred visited mobile network operator, as selected in accordance with conventional protocols for mobile network operator selection. Optionally, the plurality of mobile network operators comprises at least one mobile virtual network operator. The improved mobile network operator may be a visited mobile network operator or a mobile virtual network operator.

In some embodiments, the identifying and/or selecting are performed by a mobile network operator (optionally by the default mobile network operator), and for example within a portion of the telecommunications network (e.g. core or radio access network) associated with said mobile network operator.

In some embodiments, the method further comprises preventing the wireless communication device from registering with the default mobile network operator in response to identifying the improved mobile network operator.

In some embodiments, the network communication is received at radio access point of the radio access network, and said identifying is performed so as to identify an improved mobile network operator accessible via said radio access point, and said selecting is performed so as to select the improved mobile network operator to route the network communication via said access point.

In some embodiments, the wireless communication device first registers with the default mobile network operator. In some embodiments, identifying the improved mobile network operator is performed subsequently to having attempted to register the wireless communication device with the default mobile network operator, for example after having registered with the default mobile network operator.

In some embodiments, the improved mobile network operator is selected despite at least one other of the mobile network operators being available (and optionally the default mobile network operator) and/or suitable to route the network communication.

The network communication may be a network session. The identified improved mobile network operator may be selected for the entirety of the network session.

In some embodiments, the method further comprises determining a network characteristic of at least one (and more preferable at least two) of the mobile network operators, and identifying the improved mobile network operator in dependence on the determined network characteristic.

Optionally, the network characteristic is a network performance parameter. The network performance parameter may be associated with: Quality of Experience (QoE); Quality of Service (QoS); quality of a radio link between the wireless communication device and the radio access network, including radio signal strength and radio frequency; packet drop rate; latency; jitter; bandwidth (downlink and/or uplink); data transfer speed; cell handover quality and/or speed; and/or network load/capacity.

The network characteristic may be the availability of a network service. Optionally, the network service is: a telecommunications protocol (for example, 3G, 4G and 5G); a standard of encryption, and security features more generally; utilization of a codec; a network function, such as Voice over WiFi™ and network slicing; a service that defines a quality of service (e.g. Ultra-Reliable, Low Latency Communication); and/or network downtime (scheduled or otherwise).

In some embodiments, the method further comprises interrogating the network of at least one (and more preferably at least two) of the mobile network operators thereby to determine the network characteristic. The network of every of the plurality of mobile network operators may be interrogated, thereby to determine the network characteristic for every of the mobile network operators. The wireless communication device and/or a radio access point of the radio access network may perform the interrogating. In some embodiments, the determined network characteristic is stored in a database that is accessible by the wireless communication device, radio access network access point and/or by all of the plurality of mobile network operators.

The network characteristic may be a characteristic of a network core and/or of the radio access network. Optionally, the network characteristic is a characteristic of only a network core.

In some embodiments, the method further comprises identifying a type of network communication being, or to be, communicated by the wireless communication device and identifying the improved mobile network operator in dependence on the identified type of network communication. The type of network communication may be: a data format (for example, video, sound, voice, text, image, etc.), including data extension type; encryption protocol; and/or application, transport, internet and/or link layer protocol type. Optionally, the type of network communication is identified from: the type of UE (e.g. hardware type and/or operating software version); the payload data (assessed, for example, by means of deep packet inspection); the application layer; the transport layer; and/or link layer.

The method may further comprise ranking and/or weighting a plurality of network characteristics in dependence on importance of the network characteristics and identifying the improved network operator in dependence on the ranking and/or weighting of the plurality of network characteristics. The network characteristics may be ranked and/or weighted in dependence on their importance, in terms of QoS and/or QoE, to the identified type of network communication.

The improved mobile network operator may further be selected in dependence on a predefined set of rules.

The radio access network may be shared by the plurality of mobile network operators as a Multi Operator Core Network (MOCN) or as a Mobile Operator Radio Access Network (MORAN).

According to another aspect of the disclosure, there is provided a telecommunications network comprising: a radio access network, shared by a plurality of mobile network operators, for receiving a network communication from a wireless communication device, the wireless communication device having a default mobile network operator with which to register; a processor configured to identify, from the plurality of mobile network operators, an improved mobile network operator having an improved network characteristic compared to the default mobile network operator; and a controller for selecting the improved mobile network operator through which to route the network communication.

The processor and/or the controller may be provided as part of a radio network access network.

In some embodiments, the telecommunications network further comprises an interrogator for interrogating at least one (and more preferably at least two) of the mobile network operators thereby to determine a network characteristic of the at least one (and more preferably at least two) of the mobile network operator(s).

In some embodiments, the telecommunications network further comprises a database for storing the network characteristic, and more preferably the database is provided as part of the radio access network.

According to yet another aspect of the disclosure there is provided a computer-readable storage medium comprising instructions that, when executed by a processor associated with a telecommunications network, causes the telecommunication network to perform the aforementioned method.

The disclosure extends to any novel aspects or features described and/or illustrated herein. The disclosure extends to methods and/or apparatus substantially as herein described and/or as illustrated with reference to the accompanying drawings. The disclosure also provides a computer program and a computer program product for carrying out any of the methods described herein and/or for embodying any of the apparatus features described herein, and a computer readable medium having stored thereon a program for carrying out any of the methods described herein and/or for embodying any of the apparatus features described herein.

The disclosure also provides a signal embodying a computer program for carrying out any of the methods described herein and/or for embodying any of the apparatus features described herein, a method of transmitting such a signal, and a computer product having an operating system which supports a computer program for carrying out any of the methods described herein and/or for embodying any of the apparatus features described herein.

Any apparatus feature as described herein may also be provided as a method feature, and vice versa. As used herein, means plus function features may be expressed alternatively in terms of their corresponding structure, such as a suitably programmed processor and associated memory.

Any feature in one aspect of the disclosure may be applied to other aspects of the disclosure, in any appropriate combination. In particular, method aspects may be applied to apparatus aspects, and vice versa. Furthermore, any, some and/or all features in one aspect can be applied to any, some and/or all features in any other aspect, in any appropriate combination. It should also be appreciated that particular combinations of the various features described and defined in any aspects of the invention can be implemented and/or supplied and/or used independently.

In this specification the word ‘or’ can be interpreted in the exclusive or inclusive sense unless stated otherwise.

Furthermore, features implemented in hardware may generally be implemented in software, and vice versa. Any reference to software and hardware features herein should be construed accordingly.

The disclosure extends to a method of selecting a mobile network operator, a telecommunication network and a computer-readable storage medium substantially as described herein and/or substantially as illustrated with reference to the accompanying drawings.

### BRIEF DESCRIPTION OF THE DRAWINGS

The present disclosure is now described, purely by way of example, with reference to the accompanying diagrammatic drawings, in which:

FIG. 1 is a schematic diagram of a telecommunications network employing Radio Access Network (RAN) sharing.

FIG. 2 shows a process flow for a method of selecting an improved mobile network operator.

FIG. 3 show examples of network characteristics for selecting an improved mobile network operator.

FIGS. 4 and 5 show, in more detail, schematic diagrams of telecommunications networks employing Radio Access Network (RAN) sharing.

FIGS. 6 and 7 show process diagrams of the networks of FIGS. 4 and 5, respectively, selecting an improved mobile network operator.

FIG. 8 shows, in more detail, a process for selecting an improved mobile network operator.

### DESCRIPTION

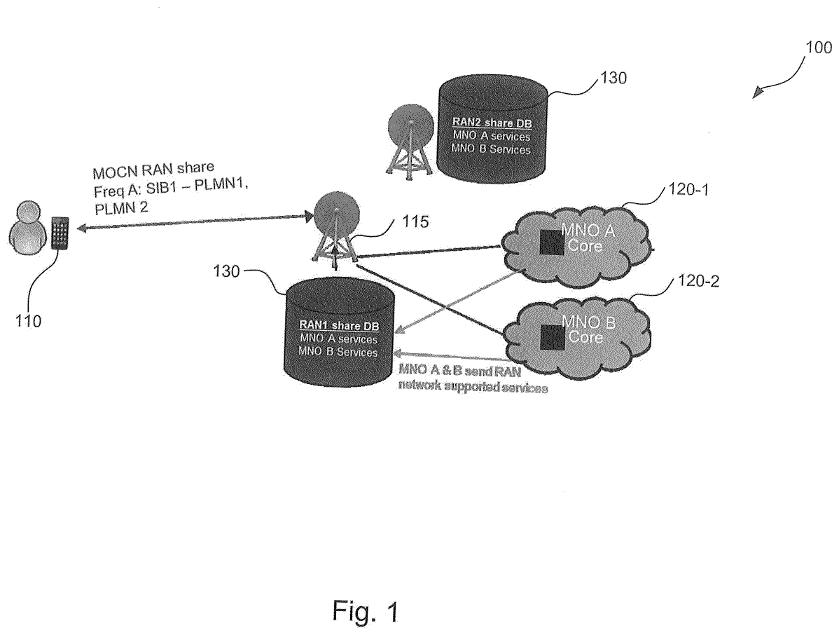

FIG. 1 is a schematic diagram of an overview of a telecommunications network 100 comprising User Equipment (UE) 110 (e.g. in the form of a mobile cellular device, laptop or tablet) that is configured to access the telecommunications network 100 via a Radio Access Network (RAN), as provided by a RAN access point 115 (e.g. in the form of a macro-, micro-, pico- or femto-cell site). In turn, the RAN access point 115 is connected to a plurality of core networks 120. The plurality of core networks includes a first core network, operated by a first mobile network operator (MNO A) 120-1, and a second core network, independently operated by a second mobile network operator (MNO B) 120-2.

The first and second mobile network operators share, at the RAN access point 115 site, the RAN that is available to the UE 110 according to any known arrangement for doing so (e.g. MORAN or MOCN).

The UE 110 is registered to MNO A, which is referred to as its Home MNO or Home Public Land Mobile Network (HPLMN). According to exiting protocols, the UE would, by default, connect to its Home MNO (referred to as a “default MNO”) when it is available. When the Home MNO is not available, the UE would register with a preferred visited MNO (also referred to as a “default MNO”). The default MNO may not always be the best network to serve the UE, at least in terms of quality of service or experience.

In order better to serve the network is configured to allow the UE to utilize the network of an available MNO that offers an improved service (herein referred to as the “improved MNO”) compared to the default MNO. To this end, the network comprises a database 130 storing network characteristics associated with the telecommunications network 100, and in particular associated with the individual core networks of MNO A 120-1 and MNO B 120-2. The network characteristics relate to network performance and/or to available network services, and by qualitative comparison of the network characteristics an improved MNO can be identified.

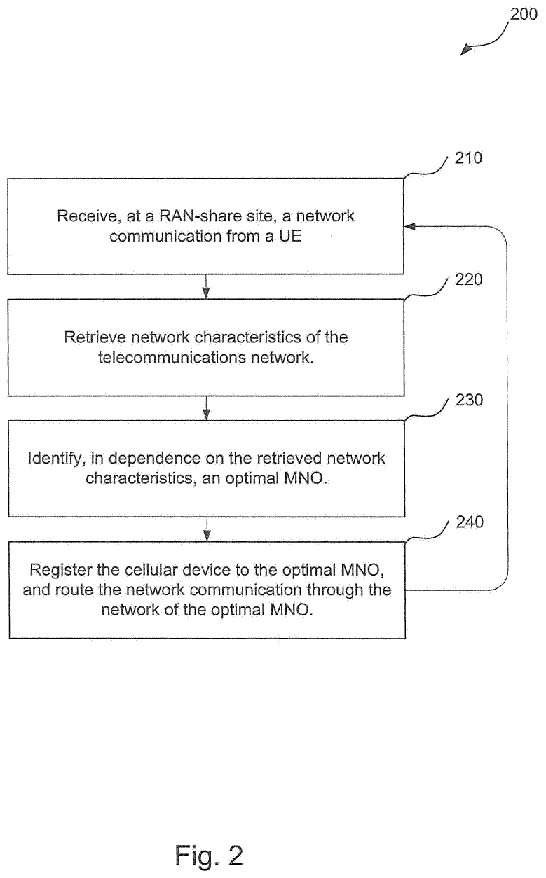

FIG. 2 shows an overview of a process 200 by which the network 100 selects an improved MNO.

In 210, a network communication from the UE 110 is received at the RAN access point 115. For example, the network communication commences with an attach request for connecting to the Home MNO.

In 220, the network characteristics of the telecommunications network 100—and in particular of the core networks of the first 120-1 and second 120-2 MNOs—are retrieved from the database 130. Based on a comparison of the network characteristics, an assessment is made at the RAN access point 115 so as to identify the improved MNO 230.

Once the improved MNO has been identified, the UE 110 is then temporarily registered with this improved MNO. Network communications from the UE are therefore subsequently routed through the improved MNO 240. The connection between the UE and the improved MNO is maintained, at least, for the duration of the network communication session, after which point the process 200 repeats.

If no improved MNO is identified (i.e. the default MNO is the most suitable), then the UE is connected (or is allowed to continue communicating) with its default MNO, as per existing protocols.

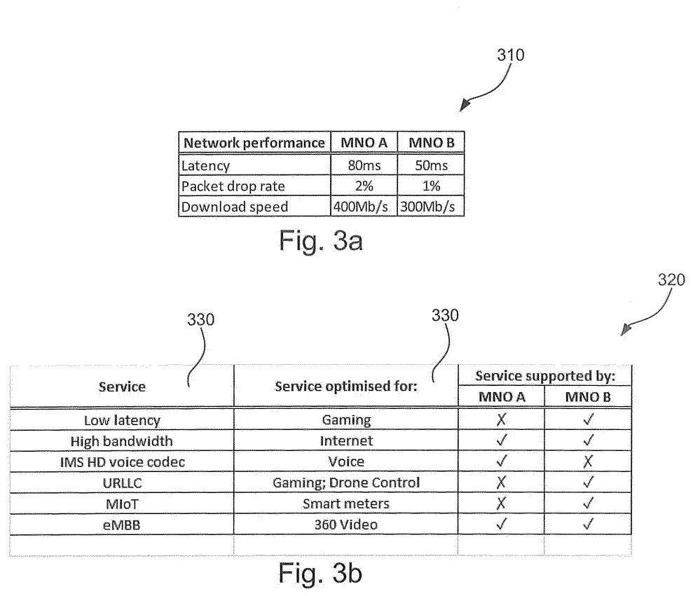

FIG. 3 show exemplary datasets of network characteristics for MNOs A and B, as stored in the database 130 and as used to identify the improved MNO.

In particular, FIG. 3a shows an exemplary dataset relating to network performance parameters 310 (at a particular point in time) for each MNO that is available from the RAN access point 115.

The dataset 310 includes values for latency, packet drop rate and download speed.

The dataset 310 is populated by interrogating the network 100 (in particular the networks of each MNO 120) so as to measure network performance. For example, the network 100 is interrogated by the RAN access point 115.

Although not shown in FIG. 3a, further examples of network performance parameters for populating within the dataset 310 and for use in identifying the improved MNO, include metrics and/or status flags regarding: jitter; bandwidth; throughput; wireless signal strength; and radiofrequency spectrum characteristics.

FIG. 3b shows an exemplary dataset relating to available network services 320 (at a particular point in time) for each available MNO 120. The dataset 320 includes a list of services 330 and flags as to whether (as indicated by a tick) or not (as indicated by a cross) each available MNO supports a given network service 330.

Although not shown in FIG. 3b, further examples of network characteristics relating to available services for populating within the dataset 310, include status flags regarding the availability of: mobile telecommunications standards (including 3G, 4G and 5G availability); network functions, such as network slicing (and the available types of network slices) and Voice Over Wi-Fi™ (VoWiFi); encryption (including types), and security features more generally; specific codecs; and services that define a quality of service (e.g. Ultra-Reliable, Low Latency Communication).

When the network characteristics relating to the availability of network slices is used to determine the improved MNO 120, a UE is redirected to an improved MNO if the improved MNO provides an equivalent, corresponding or improved type of network slice to that to which the UE would be (or is) connected on their default MNO.

The dataset 320 is populated by interrogating the network (in particular the networks of each MNO 120) so as to assess the availability of network services and/or by directly receiving status flags from each MNO. For example, MNOs A and B send to the database 130 lists of services that are available through their respective networks.

A plurality or a single network characteristic is used to determine the improved MNO. Furthermore, the datasets relating to network performance 310 and/or available services 320 are used to determine the improved MNO. Where a plurality of network characteristics are used to determine the improved MNO, the network parameters are ranked in order of, and/or weighted according to, importance.

In the event of a deadlock, that is when no one single improved MNO can be identified based on network characteristics, then—save for any MNO-selection rules to the contrary—one of the MNOs jointly having the best network characteristics is chosen; this is, for example, chosen at random.

The network characteristics, and in particular the network performance parameters, relate to: the network from the UE to the RAN access point (i.e. the wireless network); from the RAN access point to a given MNO's core network (e.g. MNO A or B); and/or from a given MNO's core network to a remote network.

The datasets 310, 320 are updated on a regular and/or event-triggered basis. For example, the datasets are updated once every 24 hours and/or when the number of connected UEs surpasses a particular threshold.

In one example, specific network characteristics are updated at different frequencies. For example, more critical network characteristics and/or those with greater variance are updated more frequently than less critical and/or more stable network characteristics. For example, latency is updated more frequently than jitter. Typically, network parameters are updated more frequently than available network services.

In order to improve the suitability of an improved MNO, the network 100 is configured to select the improved MNO in dependence on the network characteristics that are most critical for the type of network communication that the UE is (or will be) engaged. That is, the network characteristics that are used (or their ranking and/or weighting) to identify an improved MNO is dynamic and dependent on the type of network communication.

In this way, network efficiency is improved by tailoring the selection of the improved MNO to the type of network communication, since it ensures that that network resources are not under- or over-utilized. For example, there is little benefit to a user—but an unnecessary load on a network—to select a MNO that is optimized for ultra-low latency if the network communication merely relates to a local voice call.

Accordingly, in this example, process 200 further includes identifying the type of network communication from the UE thereby to help determine the improved MNO for that network communication.

The determination as to the type of network communication can be made by any component within the network. In one example, the UE itself identifies the type of network communication, and forwards this to the RAN access point 115. In another example, the determination as to the type of network communication is made remotely from the UE, and for example by the RAN access point 115, or within one of the core networks 120 (and, most appropriately, by the default MNO).

The type of network communication from the UE includes: whether the network communication is for a circuit- and/or IP-switched network; the format of the data being transferred (e.g. audio, video, etc.); the network protocols used to transfer the data; and the type/identity of the application and/or device receiving the network communication.

The dataset 320 includes markers regarding types of network communications 330 for which services are optimized. In this way, an improved MNO is identified from the dataset 320 by a lookup function that finds the identified type of network communications in the dataset, and then finds the MNO that provides services that are optimized for the identified network communication, according to the markers provided in the dataset.

For example, the availability of Ultra-Reliable, Low Latency Communication (URLLC) service will generally better support sessions relating to gaming and remote control of drones. According to the dataset 320, MNO B, but not MNO A, offers URLLC. If a network communication is identified as relating to gaming or remote control of drones, MNO B is therefore determined to be the improved MNO, and the UE's traffic relating to gaming or remote control of drones is routed through MNO B (rather than its default MNO—MNO A).

In another example, the network selects MNO A for a session relating to file transfer, given the faster available download speed recorded in dataset 310. However, the network selects MNO B for a media streaming session, given the lower packet drop rate, also as recorded in dataset 310.

In yet another example, enhanced Mobile Broadband (eMBB) service could better support the streaming of 360 Video (e.g. virtual reality media). Both MNOs A and B offer eMBB, and so—based only on the availability of this service—both MNOs A and B are suitable (and neither is more preferable) for handling 360 Video. Further network characteristics and/or MNO-selection rules are therefore used to identify which of MNO A or B is the improved MNO for a network communication relating to 360 Video.

The MNO-selection rules comprise rules for selecting a MNO that do not relate to network characteristics. Instead, for example, the MNO-selection rules relate to agreements between MNOs that are available to act as improved MNOs. The MNO-selection rules are predefined and are also stored in the database 130 and called upon in the same way as the datasets 310, 320. An example of an MNO-selection rule is that one MNO can only act as an improved MNO for up to a certain number of UEs at any given moment.

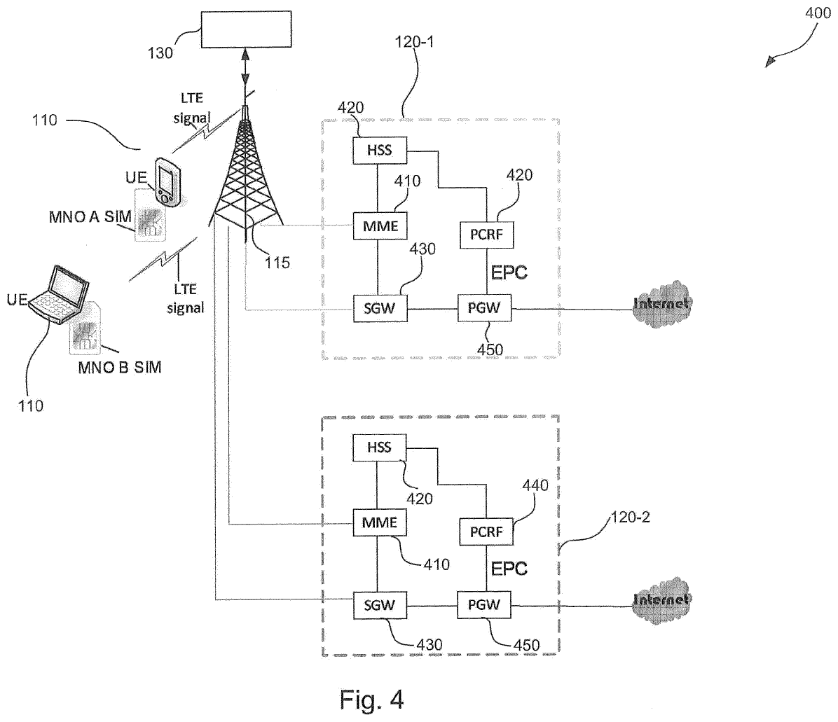

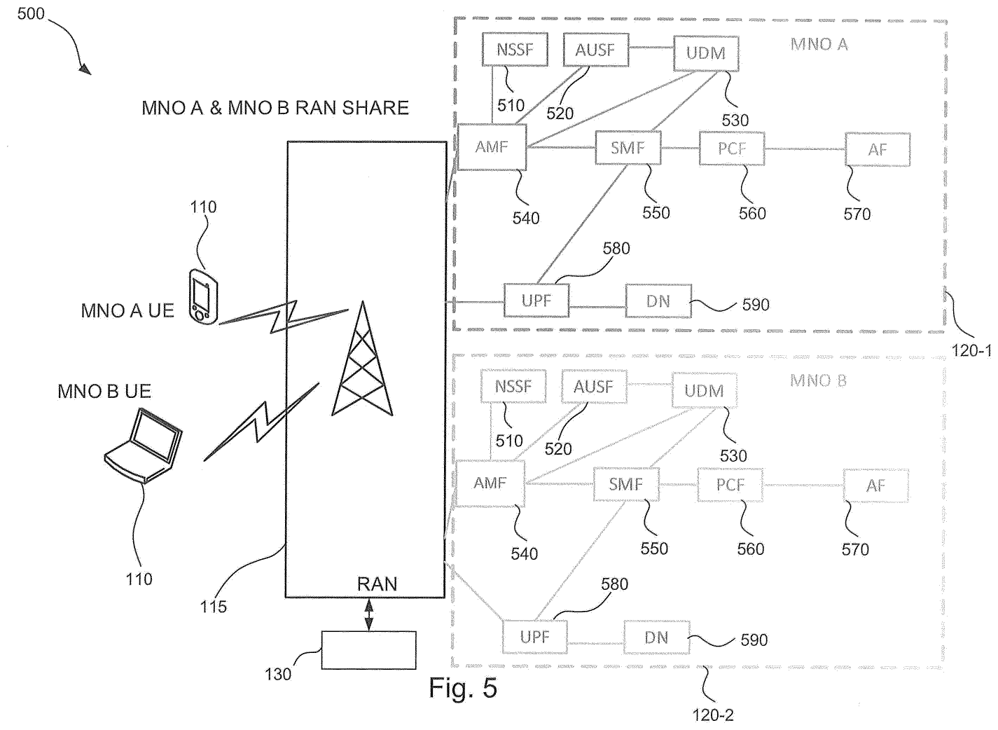

FIGS. 4 and 5 show in more detail examples of telecommunications networks in which RANsharing is provided and which are capable of selecting an improved MNO.

In particular, FIG. 4 shows a network 400 that includes a RAN-share arrangement and that operates in accordance with the LTE standards (such as 4G). The core network of MNO A 120-1 and MNO B 120-2 each comprise, as part of an Evolved Packet Core (EPC), the following functional components:
Mobility Management Entity (MME) 410;
Home Subscriber Server (HSS) 420;
Serving Gateway (SGW) 430;
Policy and Charging Rules Function (PCRF) 440; and
Packet Data Network Gateway (PGW) 450.

FIG. 5 shows a telecommunications network 500 that includes a RAN-share arrangement and that operates in accordance with 5G technology. Accordingly, the core network of MNO A 120-1 and MNO B 120-2 each comprise the following functional components:
Network Slice Selection Function (NSSF) 510;
Authentication Server Function (AUSF) 520;
Unified Data Management (UDM) 530;
Access and mobility Management Function (AMF) 540;
Session Management Function (SMF) 550;
Policy Control function (PCF) 560;
Application Function (AF) 570;
User Plane Function (UPF) 580; and
Data Network (DN) 590.

As shown in FIGS. 4 and 5, the RAN access point 115 is in communication with—or includes—the database 130. In this way, a single database 130 is provided per RAN access point.

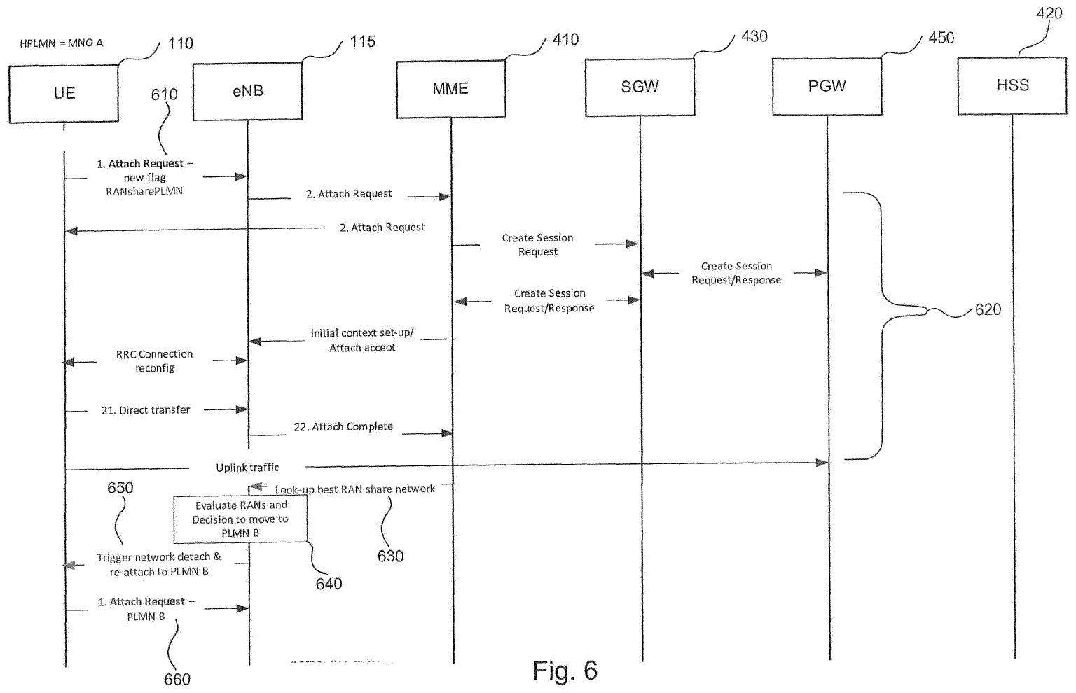

FIGS. 6, 7 and 8 show in more detail, and with reference to the networks of FIGS. 4 and 5, a process by which an improved MNO is selected.

In particular, FIG. 6 shows a process by which the network 400 selects an improved MNO. In 610, the UE 110 sends an attach request to the RAN access point 115.

The UE stores, within a RAN-share field, information to support the process of selecting an improved MNO. The RAN-share field includes, as part of the USIM, a RAN-share flag indicating that the UE is available to participate in the process of selecting an improved MNO; this flag is forwarded to the RAN access point 115 as part of the attach request at 610. If the RANshare flag is positive, then the process of selecting an improved MNO proceeds. If the RAN-share 15 flag is null, then the UE proceeds with its default MNO (e.g. the Home MNO, if available).

The RAN-share field also includes, for storage as part of the USIM, a list of available MNOs—as received from the RAN access point 115—that are available to act as an improved MNO (herein referred to as the “RAN-share MNO list”); this list is provided via a SIB1 message from the RAN access point 115.

In one example, the RAN-share flag is a binary marker (e.g. indicating that RAN-share in accordance with the present invention is either available or unavailable) or the flag is the RANshare MNO list (e.g. in which a populated RAN-share MNO list indicates that RAN-share in accordance with the present invention is available, whereas a blank or absent RAN-share MNO list indicates that it is unavailable).

The UE 110 first establishes a connection to its default MNO 620, via the RAN access point 115, MME 410, SGW 430, and PGW 450 in accordance, for example, with 3GPP TS23.401, section 5.3.2 (the contents of which are herein incorporated by reference).

Once the UE 110 is connected to its default MNO and has communicated uplink traffic to the default MNO, recognizing the presence of a RAN-share flag, the MME 410 instructs 630 the RAN access point 115 to determine the improved MNO.

Accordingly, the RAN access point 115 determines—by accessing the database 130—the improved MNO 640. Once the improved MNO is identified, the RAN access point 115 instructs the UE to detach from the default MNO and to re-attach to the improved MNO 650. The UE 110 therefore then sends a new attach request to the RAN access point 115, which includes a request to connect to the determined improved MNO 660, and the UE connects to the improved MNO in a corresponding manner to that associated with 620.

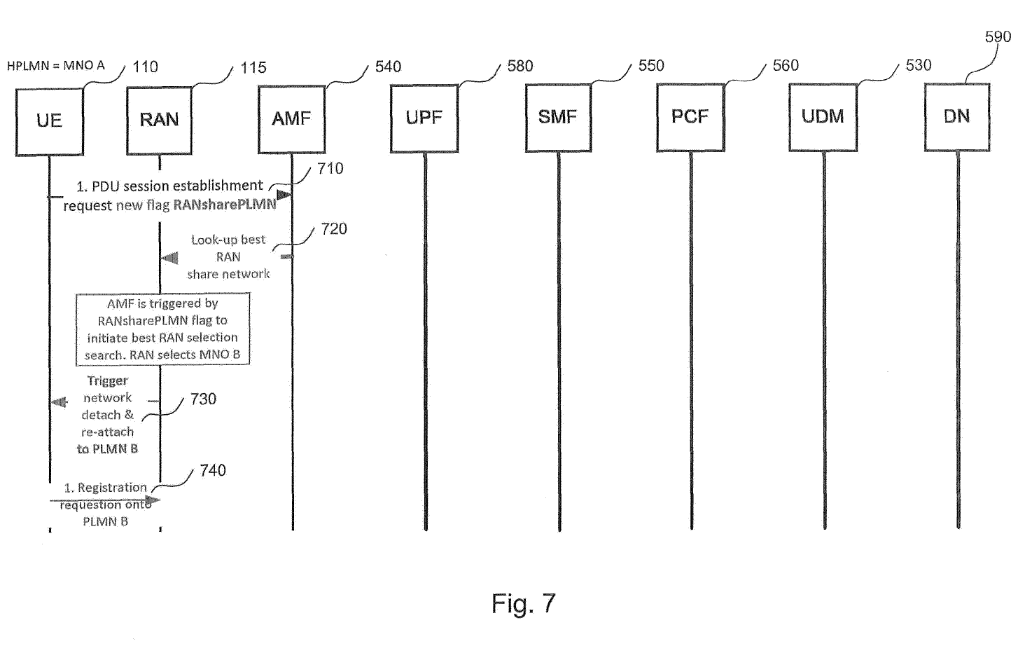

FIG. 7 shows a process by which the network 500 selects an improved MNO. In a first step 710, the UE 110 establishes a Protocol Data Unit (PDU) session with its default MNO as per, for example, 3GPP TS.23.502, section 4.3.2 (the contents of which are herein incorporated by reference). In a corresponding manner to that described with reference to FIG. 6, the process described with reference to FIG. 7 also utilizes the RAN-share field to facilitate the selection of an improved MNO.

The decision whether to initiate the process to select the improved MNO is made when the PDU session request starts, that is once the UE starts to send data over the network 500. Accordingly, and in a manner corresponding to the process described with reference to FIG. 6, the AMF 540 instructs the RAN access point 115 to determine the improved MNO. Once the RAN access point 115 identifies the improved MNO, the RAN access point 115 instructs the UE to detach from the default MNO 730 and to re-attach to the improved MNO 740.

In the processes described with reference to FIGS. 6 and 7, the UE remains connected to the improved MNO for the duration of its network session, after which the UE disconnects from the improved MNO, and the respective processes repeat.

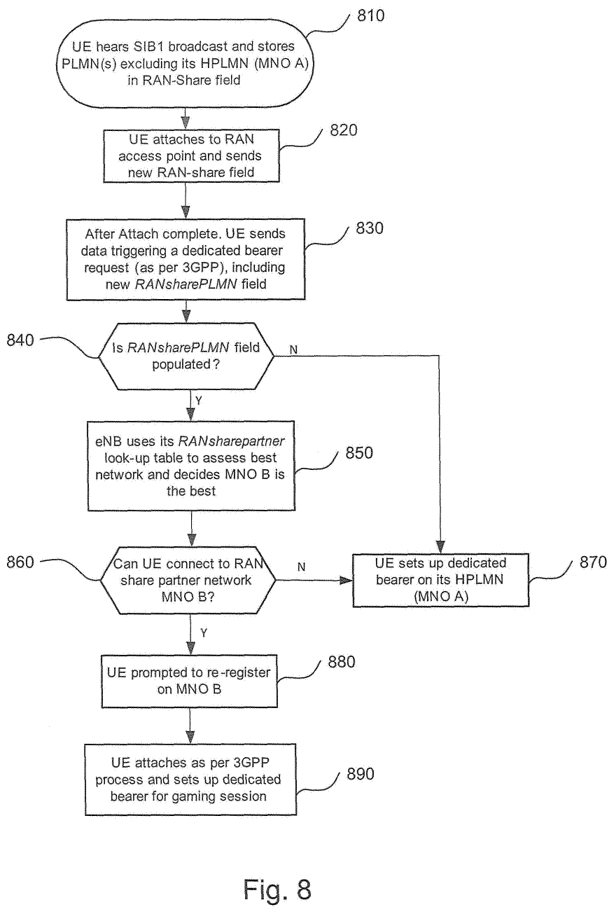

FIG. 8 is a diagram showing in more detail the process 800 by which a UE connects to an improved MNO. In 810, from a given RAN access point 115, the UE received a SIB1 broadcast that provides a list of MNOs that are available from the RAN access point. The UE stores the list of MNOs, less the default MNO, in the RAN-share field.

Next at 820, the UE attaches to the RAN access point 115 (e.g. the eNodeB) and forwards to the RAN access point the RAN-share field, including the RAN-share MNO list.

Once the UE has attached to the default MNO, the UE initiates a data uplink (i.e. a network communication); this data uplink triggers a dedicated bearer request 830.

The status of the RAN-share flag is then assessed 840. If the RAN-share flag is positive, the RAN access point 115 accesses the database 130, compares the relevant network characteristics and thereby identifies the improved MNO 850.

A determination is then made as to whether the improved MNO will permit the UE to register onto its network 860. If so, the UE is then prompted to register with the improved MNO 880, and accordingly the UE sets up a dedicated bearer session with the improved MNO for the duration of its session (e.g. a gaming session) 890.

If the RAN-share flag is negative or if the improved MNO does not permit the UE to register onto its network, then the UE connects to the default MNO 870. Alternatively, rather than connecting to the default MNO, the process 800 repeats but excludes (for example by excluding from the RAN-share MNO list) the inaccessible improved MNO that was previously identified. In this way, another available improved MNO can be identified and selected.

It will be appreciated that the aforementioned methods of selecting an improved MNO are available to be performed at any RAN access point where there is a RAN-share agreement amongst a plurality of MNOs. Since MNOs and network characteristics may vary across different RAN access points, the improved MNO may also vary at each RAN access point. The process to determine the improved MNO therefore restarts when a UE connects to a new RAN access point.

It will also be appreciated that, at a given RAN-access point 115, there may be available three or more MNOs that are in a RAN-share agreement. Accordingly, the database 130 comprises network characteristics relating to all of the available MNOs, and the network characteristics of each MNO is compared so as to identify the improved MNO.

### Alternative and Modifications

In an alternative example, a separate database 130 is provided for each MNO (within the core network of each MNO), and each database is therefore accessed by the part of the network that determines the improved MNO (e.g. the RAN access point).

In another alternative, the determination as to improved MNO is made away from the RAN access point 115, and for example by the UE (subject to the database 130 being forwarded to the UE) or by an MNO (for example, by the default MNO).

The selection of the improved MNO is also made in dependence on network efficiency, load and/or commercial arrangements when selecting an improved MNO. As a result, under such circumstances, the improved MNO may not necessarily be the best MNO, or indeed any better (from a quality of service or experience point of view) than the home MNO, but may instead offer improved network balancing across MNOs.

In yet another alternative, the connection between the UE and the improved MNO is maintained for a fixed period of time or indefinitely (for a given RAN access point).

Each feature disclosed in the description, and (where appropriate) the claims and drawings may be provided independently or in any appropriate combination.

Reference numerals appearing in the claims are by way of illustration only and shall have no limiting effect on the scope of the claims.

1. A method of selecting a mobile network operator for a network communication from a wireless communication device, the wireless communication device being registered with a default mobile network operator, comprising the steps of:
receiving, from the wireless communication device, the network communication at a radio access network shared by a plurality of mobile network operators;
identifying, from the plurality of mobile network operators, an improved mobile network operator having an improved network characteristic compared to the default mobile network operator; and
selecting the improved mobile network operator through which to route the network communication.

2. The method according to claim 1, wherein at least one of the identifying or the selecting are performed by a mobile network operator.

3. The method according to claim 1, further comprising preventing the wireless communication device from registering with the default mobile network operator in response to identifying the improved mobile network operator.

4. The method according to claim 1, wherein the network communication is received at a radio access point of the radio access network, the identifying is performed so as to identify an improved mobile network operator accessible via the radio access point, and the selecting is performed so as to select the improved mobile network operator to route the network communication via the radio access point.

5. The method according to claim 1, wherein identifying the improved mobile network operator is performed subsequently to having attempted to register the wireless communication device with the default mobile network operator.

6. The method according to claim 1, further comprising interrogating a network of at least one of the mobile network operators thereby to determine a network characteristic of at least one of the mobile network operators, and identifying the improved mobile network operator in dependence on the determined network characteristic.

7. The method according to claim 1, wherein the network characteristic is a network performance parameter, an availability of a network service, or a characteristic of a core of a network.

8. (canceled)

9. (canceled)

10. The method according to claim 1, further comprising the step of identifying a type of network communication being, or to be, communicated by the wireless communication device, and identifying the improved mobile network operator in dependence on the identified type of network communication.

11. The method according to claim 1, wherein the identified improved mobile network operator is selected for an entire session that is associated with the network communication.

12. The method according to claim 1, wherein the improved mobile network operator is selected despite at least one other of the mobile network operators being available or suitable to route the network communication.

13. The method according to claim 6, further comprising ranking or weighting a plurality of network characteristics in dependence on an importance of the network characteristics, and identifying the improved network operator in dependence on the ranking or the weighting of the plurality of network characteristics.

14. The method according to claim 13, wherein the network characteristics are ranked or weighted in dependence on the importance of the network characteristics to the identified type of network communication.

15. The method according to claim 1, wherein the improved mobile network operator is further selected in dependence on a predefined set of rules.

16. The method according to claim 1, wherein the radio access network is shared by the plurality of mobile network operators as a Multi-Operator Core Network (MOCN).

17. The method according to claim 1, wherein the radio access network is shared by the plurality of mobile network operators as a Mobile Operator Radio Access Network (MORAN).

18. A telecommunications network comprising:
a radio access network, shared by a plurality of mobile network operators, for receiving a network communication from a wireless communication device, the wireless communication device having a default mobile network operator with which to register;
a processor configured to identify, from the plurality of mobile network operators, an improved mobile network operator having an improved network characteristic compared to a network characteristic of a default mobile network operator; and
a controller for selecting the improved mobile network operator through which to route the network communication.

19. The telecommunication network according to claim 18, wherein at least one of the processor of the controller is provided as part of a radio network access point.

20. The telecommunication network according to claim 18, further comprising an interrogator for interrogating at least two of the mobile network operators thereby to determine a network characteristic of the at least two of the mobile network operators.

21. The telecommunication network according to claim 18, further comprising a database for storing the network characteristic.

22. A non-transitory computer-readable storage medium storing instructions that, when executed by a processor associated with a telecommunications network, causes the telecommunication network to perform the method of claim 1.
